(19) United States
(12) Patent Application Publication
(10) Pub. No.: US 2010/0164751 A1
(43) Pub. Date: Jul. 1, 2010

(54) Telemetry signal collection, process, diagnosis, transmission, control and activation system

(75) Inventor: Kiriakos Tsigiroglou, Voula - Athens (GR)

Correspondence Address: Tsigiroglou Kiriakos, 78 Vouliagmenis Ave, Voula- Athens, 16673, GR

(73) Assignee: INTEC ANONIMOS TEHNIKI ETERIA EMPORIAS KE IPOSTIRI SISTIMATON IPSILIS TEHNOLOGIAS KE IDIOTIKI EPHIHI, Athens (GR)

(21) Appl. No.: 11/920,562

(22) PCT Filed: May 18, 2006
(86) PCT No.: PCT/GR2006/000025

§ 371 Date: Nov. 16, 2007

(30) Foreign Application Priority Data
May 18, 2005 (GR) 2005100258

(51) Int. Cl. G08B 21/00; G05B 19/05; G05B 19/00; G06F 1/26

(52) U.S. Cl. 340/870.09; 340/5.2; 700/297

(57) ABSTRACT

This patent refers to an electronic equipment system, which is intended to collect data from the equipment of certain area, which it monitors, to process this data, diagnose faults of the equipment and transfer data to a central control system, to accept commands, to activate the active equipment installed in the monitored area, so that it allows the central control system operator to diagnose equipment faults and resolve these faults related to the equipment installed and monitored, installed in the mobile telephony antenna shelters, located in remote areas. The system provides the following possibilities: Operational access control of individuals in the monitored area, Local processing power, Data transmission from the monitored area to the central control system through the GSM network, Processing of information and transmission of intelligently correlated and processed data to the operator for decision making, Possibility to the central control system operator to act upon the remote system remotely and carry out measurements of the remote equipment operations. The results of these actions are savings of time and maintenance cost and the manpower used, since either the faults determined are resolved by the operator remotely or the operator can make the right decision, through the intelligently correlated and processed data, and send only the required specialized team of experts for fault resolution at the remote site.

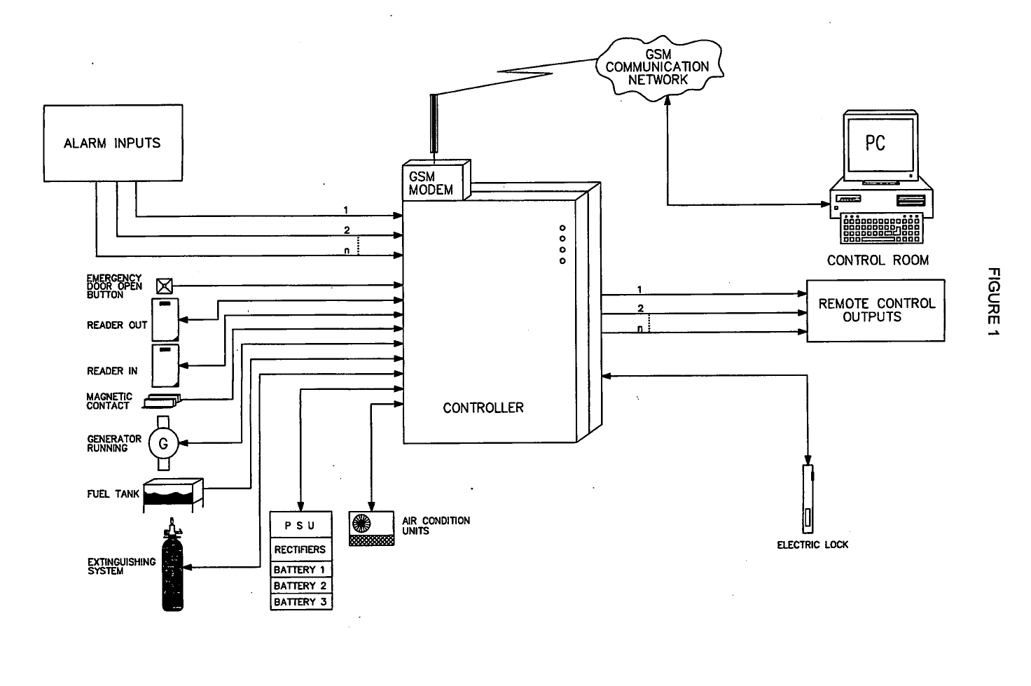

1. This patent refers to an electronic equipment system, which is intended to collect data from the equipment of certain area, which it monitors, to process this data, diagnose faults of the equipment and transfer data to a central control system, to accept commands, to activate the active equipment installed in the monitored area and to trigger active equipment installed in the monitored area, thereby allowing the remote central control operator to diagnose equipment faults and resolve these faults related to the equipment installed and monitored, installed in the mobile telephony antenna shelters, located in remote areas.

The result of these processes and actions is the saving of human resources.

2. a. This patent constitutes an improvement of the previous invention of KINTEC S.A. with inventor Mr Kiriakos Tsigiroglou, son of John, already patented and registered under Patent Nr 1004348 of 26 Sep. 2003 (in Greece), and internationally classified (INT.CL:H04Q 7/22, G01W 1/02, G01W 1/10, H02H 5/00).

The above patent aimed at the collection, process and provision of telemetry signals via the microwave base stations management network of mobile telephony.

b. In addition to the above registered invention of KINTEC S.A., there are other Kintec devices aiming at selectively collecting, processing and transmitting data from a monitored area.

This equipment is designed for use in an industrial environment and does not provide Programmable Logical Controller (PLC) logic with the use of software.

This equipment is also connected with external autonomous sensors, which incorporate the essential signaling logic in order to communicate with the equipment, which in turn transmit raw data to the remote central operator.

3. The differentiation that the above patent provides consists of the following:

a. It provides functionality of Access Control of individuals in the monitored areas, with the use of special electronic access cards, which carry unique, tamper-free access codes, and utilizing locally kept databases of authorized card holders so as to permit their access to authorized card holders only, even if communication with the remote central control station has been lost.

b. It provides local processing capacity in order to be connected directly with the monitored local active equipment, without the need for external sensors to decide if the monitoring value (e.g. voltage) is at critical level and when appropriate signaling should be initiated.

This is achieved with embedded electronic circuits and embedded special measurement, digitalization and decision software for detecting critical levels of the monitored values (e.g. voltage or temperature).

c. The transmission of information to the remote central control station takes place henceforth via the public mobile telephony GSM network and not only from the private microwave management network of mobile telephony base stations.

d. Information that is dispatched to the remote central control system is processed in such a way as to present to the operator not simply measured values but direct prompts for action such as “Call Fire Brigade”, “Call Electric Company”, “Call air-conditioning service” etc. This has been achieved by embedding in the software of the system all accumulated experience about the installed active equipment and by the use of Programmable Logical Controller (PLC) materialized in the software of the system.

e. The patent allows the operator of the remote central control system to act remotely in order to prevent spreading the fault to other installed active sub-systems e.g. by shutting down air-conditioning units in order to prevent emergency batteries overload if the generator fails to start.

Specifically:
Restoration/interruption of power to the air-conditioning units
Start/Stop of generator
Restoration/interruption of power to battery charging rectifiers
Activation/Deactivation of generator pre-heat system
Activation of fire extinguishing system in the generator area in case of fire if the automatic extinguishing system fails to start following a fire pre-alarm/alarm signal
Release of the electric lock at main door of mobile telephony antenna shelters in cases of emergency.

f. The patent allows the operator of the remote central control system to check, if he considers it necessary, the measurement values that led to a specific prompt for action. For example if the system prompts for a call to the Electric Company, the operator can individually check the measured values of the voltages supplied by the mains grid, the generator and the batteries, as well as the level of the generator fuel.

g. All the above a, b, c, d, e, f are provided in a unified system of electronic material and software and each addition of new active equipment in the mobile telephony antenna shelter (such as new type of generator, air-condition units, etc) are parametrically embedded into the system and are monitored via a unified software by the remote central control system.

4. This patent generates cost savings because it minimises unnecessary movements to mobile telephony shelters by giving the operator of the remote central control system correct and ample information in order to mobilize the suitable personnel for the recovery of serious fault. For example, a single “air-conditioning out of order” signal can lead to an unnecessary dispatch of the air-conditioning service team while the true cause of the problem is that a phase of the mains supply is missing and the generator failed to start due to lack of fuel.

After establishing that the air-conditioning is not working, the patent, using combined logic, checks the existence of phase R which is recorded in the database as supplying the air-conditioner, checks if the generator is working and if not, checks the level of available fuel. Therefore the system prompt “Call Fuel Supply Contractor” is the only useful prompt with value to the operator, who can then act correctively, thus minimising both time and cost of fault recovery.

5. The patent is designed so it can be industrially mass produced.

6. The system is unified with regard to electronic material and software, does not use industrial PLCs, contains an embedded system of personnel access control and is expandable without requiring any design changes.

7. The system comprises of the following:

a. A basic unit with microprocessor, a communication port for the interconnection with the GSM/GPRS modem, an access control card reader interconnection port, an emergency button interconnection port, an electric lock interconnection port, input ports for incoming measurement digital data, an output port for interconnection with the monitored tele-controlled active equipment, a 230 VAC/18 VAC power supply and a 12V/7.2 Ah lead batteries, as well as the essential internal wiring. A special type of cable is used for connecting the unit to mains supply.

b. One unit with two electronic devices that use microprocessors, ports for communicating with the basic unit, input ports for interconnection with the under measurement of batteries voltages, mains phase (R/S/T) voltages, corresponding generator phase (R/S/T) voltages, ports for interconnection with the two electronic devices controlling the motors of the six motorised switches that control loads, a 13.8 VDC-5 A power supply and a 12-12 Ah lead batteries as well as the essential internal wiring and special type cables for connection with the electric distribution panel.

An electronic device for interconnection with the fuel level sensor is also included.

c. Peripheral devices for the measurement of environmental parameter values in the mobile telephony shelter such as humidity, temperature, fuel level, etc.

d. Peripheral access control devices such as card readers, electric lock, emergency button (for releasing the lock) etc.

e. Unified software essential for the operation of the system.

This consists of:
Microprocessor software stored in rewritable semiconductor memory for the access control, measurements, authorized card database, communication management and prohibition of remote actions when personnel (authorised or not) is present at the monitoring area.
Software developed in “windows” environment for the presentation of the occurring events, prompts for action, measured values, history of events and actions to the operator of the remote central control system and the activation of telemetry signals.

8. The patent collects, checks and processes information from the monitored area and signals the following diagnostic prompts to the remote central control system:

8.1 “Call the Fire Brigade”

E.g. both fire sensors have been activated, there is no personnel present at the shelter and no intrusion detected.

8.2 “Call Power Supply Maintenance Subcontractor”.

E.g. a fuse supplying the power supplies has blown, the corresponding mains phase is present and batteries voltage values and confirm the fault.

8.3 “Call Air-conditioning Maintenance Service”.

E.g. mains supply is not interrupted, monitored area temperature is at the highest permissible level, and one or both of the air-conditioning units do not cool the monitored area although they are in operation.

8.4 “Call Shelter Battery Maintenance Service”.

E.g. after an interruption of the voltage from the power supply(ies) a “low battery” condition appears for longer than the specified time and this has been confirmed by relevant batteries voltage measurements.

8.5 “Call for Fuel Supply”

E.g. generator is running and fuel level measurements confirm that fuel level has reached the minimum safety level of fuel.

8.6 “Call Generator Maintenance/Service Personnel”

E.g. following an interruption of the Electric Company, which has been confirmed by relevant voltage measurements, the generator failed to operate as confirmed by relevant generator voltage measurements and the “generator start failure” indication signal.

8.7 “Call Area Physical Security”

E.g. there are no authorized personnel in the shelter, the Electric Company has been interrupted, there is a forced entry of the door and an intruder alarm has been signaled.

8.8 “Call Aviation Light Maintenance Service”

E.g. “Aviation Light Fault” alarm has been signaled, the low light/night sensor is activated and there is no interruption of power to the aviation lights.

8.9 “Call Radio-Network Engineer”

E.g. there are no authorized personnel in the shelter, no intrusion has been detected and “water overflow” alarm is signaled.

8.10 “Call Electrician/Electric Works Maintenance Service”

E.g. there is an interruption of the mains supply phase(s), but voltage measurements of Electric Company phases are found within acceptable limits.

8.11 “Call Fire Extinguishing Maintenance Service Personnel”

E.g. both of the fire detectors have been activated and the “gas released” condition has been signaled.

8.12 “Call KINTEC”

E.g. “Interruption to the Main Panel” has been signaled, but measurements confirm that all mains phases are in normal state.

9. Commands are sent from the remote central control station to the monitored area in order to energize/de-energize 6 active devices. These actions are confirmed by relevant feedback and refer to the following:

9.1 Activation/de-activation of 2 air-conditioning units. When the operator receives the information about a power interruption to the units, he can remotely switch on the corresponding motorised switch. The action is confirmed by relevant feedback.

9.2 Activation/de-activation of 3 power supply systems. When the operator decides to perform battery discharge he de-energizes the supply of the 3 power supplies/chargers to the batteries, and the action is confirmed by relevant feedback. When resumed, the 3 motorized switches are re-energized again to put the batteries back on charge and the action is again confirmed by a feedback signal.

9.3 Activation/de-activation of generator. When the information “generator failed to start” is received, the operator initiates a remote forced start by activating the corresponding motorized switch and the action is confirmed by relevant feedback signals.

10. The operator of the central control station is able to remotely perform a number of measurements on a number of values at the shelter as follows:

10.1 Batteries voltage is measured and stored. This measurement is repeated eight times, within a time frame of 100 ms and if individual measurements are within +/−200 mV for 48 VDC systems or within +/−120 mV for 24 VDC systems, this value is registered as acceptable and stored. If not, the process is repeated until a satisfactory—stabilised value is found.

The above process secures a reliable voltage measurement, not influenced by momentary fluctuations or electric noise.

10.2 The above registered value is compared to a look up table (considering the tolerances of +/−200 mV for 48 VDC systems or +/−120 mV for 24 VDC systems) and a relevant 3 digit binary coding table is created as per the table below which is transmitted by the system to the central control station.

In detail, the coding is:

For batteries of 48 VDC nominal voltage:

For voltage of 42 V DC value sent to telemetry system: 000

For voltage of 43 V DC value sent to telemetry system: 001

For voltage of 44 V DC value sent to telemetry system: 010

For voltage of 45 V DC value sent to telemetry system: 011

For voltage of 46 V DC value sent to telemetry system: 100

For voltage of 47 V DC value sent to telemetry system: 101

For voltage of 48 V DC value sent to telemetry system: 110

For voltage of 49 V DC value sent to telemetry system: 111

For batteries of 24 VDC nominal voltage:

For voltage of 20 V DC value sent to telemetry system: 000

For voltage of 21 V DC value sent to telemetry system: 001

For voltage of 22 V DC value sent to telemetry system: 010

For voltage of 23 V DC value sent to telemetry system: 011

For voltage of 24 V DC value sent to telemetry system: 100

For voltage of 25 V DC value sent to telemetry system: 101

For voltage of 26 V DC value sent to telemetry system: 110

For voltage of 27 V DC value sent to telemetry system: 111

NOTE: The above coding is realised by three corresponding relays. State (1) is realised with an ON (energised) relay state and state (0) with an OFF (de-energised) state.

10.3 If an automatic charge command has not been issued then the program jumps to step 2 above and the whole process is repeated.

If an automatic charge command has been issued, then the registered measured voltage value is compared against a predetermined automatic charge value (trip point voltage) of 43 VDC for 48V nominal voltage systems and 21 VDC for 24V nominal voltage systems.

If this voltage is less than the predetermined automatic charge value (trip point voltage) then the auto charge relays are released, putting back the charging circuit into operation

If the voltage of the batteries becomes greater than the trip point voltage, then after 30 sec the auto-charge relays are energized again thus making the relevant circuit inactive upon normal charge of batteries.

Consideration is taken during the above process of comparing the measured voltage against the trip point voltage, to the voltage differential being ±150 mV for normal battery voltage 48 VDC and 24 VDC.

10.4 The software self-checks for its proper function by monitoring if it works within active memory regions and produces confirmation pulses every 400 ms at least.

If a 400 ms interval passes without a confirmation pulse, then the microprocessor is considered as being out of normal operation and an embedded circuit forces it to resume its operation by hard-resetting it.

10.5 The RST measurement and control device checks which of the six (3 mains, 3 generator) phases connected to it has been selected for monitoring.

It realises voltage measurement of the selected phase and stores the measured value.

This measurement is repeated eight times within 100 ms and if individual measurements are within ±1V then this value is registered as acceptable and stored. If not, the process is repeated until a satisfactory—stabilised value is found.

The above process secures a reliable voltage measurement, not influenced by momentary fluctuations or electric noise.

10.6 The above registered value of AC voltage is compared to a look up table (considering the tolerances of ±1V) and a relevant 3 digit binary coding table is created as per the table below which is transmitted by the system to the central control station.

In detail, the coding is:

For no voltage (20-180 VAC) value sent to telemetry system: 000

For voltage bigger or equal 180 VAC value sent to telemetry system: 001

For voltage bigger or equal 190 VAC value sent to telemetry system: 010

For voltage bigger or equal 200 VAC value sent to telemetry system: 011

For voltage bigger or equal 210 VAC value sent to telemetry system: 100

For voltage bigger or equal 220 VAC value sent to telemetry system: 101

For voltage bigger or equal 230 VAC value sent to telemetry system: 110

For voltage bigger or equal 240 VAC value sent to telemetry system: 111

NOTE: The above coding is realized by three corresponding relays. State (1) is realized with an ON (energized) relay state and state (0) with an OFF (de-energized) state.

10.7 It checks that the program is working correctly, that is to say as long as it works in regions of memory where the active program exists then the program creates per regular time intervals smaller 400 mSec vibrations of good operation.

If a time interval bigger than 400 mSec passes and a good operation vibration has not been created then this means that the program is not working correctly. That is to say the micro controller has “hung”.

In this case the embedded circuit of control of good operation of micro controller forces the micro controller to begin the operation from the start (hardware reset).

1) An autonomous electronic system intended for monitoring and attendance of an area, which incorporates—suitable means to collect data from the specific monitored area—means for processing the collected data—means for the transmission of this processed data and interchange of information with one or more remote control centers—means to control access to the monitored areas.

2) An autonomous electronic system as claimed in claim 1 above, characterized in that the means for data collection are interconnected with the data processing means, so that the direct exchange of information and data among them is feasible.

3) An autonomous electronic system as claimed in claims 1 and 2 above, characterized in that the means for data processing include a Central control unit (controller) comprising of at least one logical controller (microprocessor).

4) An autonomous electronic system as claimed in claims 3 above, characterized in that the central control unit (Controller) has the capability of a programmable logical controller (microprocessor).

5) An autonomous electronic system as claimed in any of the above claims characterized in that it includes a central control unit (Controller) with peripheral equipment for the access control and suitable inputs for data connection.

6) An autonomous electronic system as claimed in claims 5 above, characterized in that the central control unit (Controller) includes the following data inputs or any combination of these inputs
A) Data entry to the logical control unit (microprocessor) for access control
B) Data entry to the logical control unit (microprocessor) for data processing
C) Data entry to the logical control unit (microprocessor) for the control of the DC voltage of the batteries
D) Data entry to the logical control unit (microprocessor) for the control of the AC voltages of the electric power supply or of the generator.

7) An autonomous electronic system as claimed in claim 5 or 6 above, characterized in that the central control unit (Controller) includes at least one data output

8) An autonomous electronic system as claimed in any of the above claims characterized in that the means for data collection include
A) An electronic device for measurement and control of the batteries (DC) with the capability to program the threshold of voltage control as well as to supervise the automatic discharge/charge of the batteries and/or
B) An electronic device for measurement and control of the three phases of power supply (AC) of the electric power network supply or of the generator (where available) with the capability to program the threshold of voltage control

9) An autonomous electronic system as claimed in any of the above claims characterized in that the means for data transmission include suitable modem GSM/GPRS with wireless reception and transmission.

10) An autonomous electronic system as claimed in any of the above claims characterized in that it interconnects various data and information subsystems.

11) An autonomous electronic system as claimed in any of the above claims characterized in that it proceeds to a suitable interconnected processing of the data collected under predetermined programming conditions with simultaneous verification through the access control system.

12) An autonomous electronic system as claimed in any of the above claims characterized in that it provides the operation of Access Control of individuals in the area it monitors, with the use of a special electronic access card, bearing a unique access code, tamper-free, with the use of a local database for data monitoring of authorized cards, so that access is allowed only to those owing an authorized card, even in circumstances of loss of communication of the remote site with the remote control center.

13) An autonomous electronic system as claimed in any of the above claims characterized in that it allows the transmission of control commands from one or more remote control centers to the autonomous electronic system concerned, through the data transmission and data interchange links, so that the operator of the remote control center is able to intervene remotely upon the active equipment and reinstate it in normal condition and/or deactivate it in order to protect it and/or take the correct decision every time to send the suitable team of experts for the fault resolution on site.

14) An autonomous electronic system as claimed in any of the above claims characterized in that it includes a power supply circuit.

15) An autonomous electronic system as claimed in any of the above claims characterized in that it includes an autonomous system of Uninterrupted Operation.

16) An autonomous electronic system as claimed in any of the above claims characterized in that it includes at least two electronic devices of four relays each for the interconnection of the electrical equipment.

17) An autonomous electronic system as claimed in any of the above claims characterized in that it includes at least six motorized switches and the relevant switching material.

18) An autonomous electronic system as claimed in any of the above claims characterized in that it includes a combination of embedded logical circuits for the monitoring, measurement, display of measurements and condition and registration of the above information.

19) An autonomous electronic system as claimed in any of the above claims characterized in that it includes a combination of some or all of the embedded logical circuits:
A) Continuous monitoring, measurement and display of the condition of the electric power network phases R, S, T and possibility of signaling from the programmable desired levels of power voltage measurement, or from the combination of AND/OR logic between them.
B) As described in paragraph 4a but for R, S, T phases of the generator.
C) Continuous monitoring, measurement and display of the condition of the batteries and possibility of signaling from the programmable desired levels of power voltage measurement, or from the combination of AND/OR logic for the automatic charging of batteries after a discharge.
D) Continuous monitoring, measurement and display of the condition of the diesel fuel for the generator and possibility of signaling from the programmable desired levels of measurement as well as the combination of measurements and the type and the hours of operation of the generator for the estimation of fuel consumption and the calculation of the preventive maintenance time.
E) Continuous monitoring of access control of individuals in the controlled area, with simultaneous correlation of data with the installed software database and transmission of all changes automatically.
F) Control and transmission of after suitable processing of all data derived from External Alarm System or isolated sensors, as for example the water level indication, smoke detection, door condition, intrusion indication, temperature indication etc.

20) An autonomous electronic system as claimed in any of the above claims characterized by the embedding of electronic RELAY devices, to serve the signaling needs or action needs of the electrical equipment.

21) An autonomous electronic system as claimed in any of the above claims characterized by the fact that it provides local processing power so that it is directly connected with the local active equipment, which is monitored, without the need of external sensors with embedded logical circuits.

22) An autonomous electronic system as claimed in any of the above claims characterized by the fact that it is uniform as regards the electronic, electrical material and software and does not use industrially programmable logical controllers (PLC).

23) An autonomous electronic system as claimed in any of the above claims characterized by the fact that the data transmitted to the central remote system are already processed so that what is presented to the operator is not simple physical values, but instead, a proposition for action, that is the command “Call Fire Brigade” or “Call the Public Power Company” or “Call an Air-conditioning technician” etc. This is achieved by embedding all the experience accumulated for the installed active equipment into the System Software and with the use of the programmable logical controller applied into the System Software.

24) An autonomous electronic system as claimed in any of the above claims characterized by the fact that it is configurable with every addition of a new active equipment in the antenna shelter, embedding this additional equipment in the system and monitoring it through the unified software from the central remote control system.

25) An autonomous electronic system as claimed in any of the above claims characterized by the fact that it embeds personnel access control system.

26) An autonomous electronic system as claimed in any of the above claims characterized by the fact that is expandable without changes in its design.

27) An autonomous electronic system as claimed in any of the above claims characterized by the fact that it transmits information for verification of the actions of the central remote control system operator.

28) An autonomous electronic system as claimed in any of the above claims characterized by the fact that it is intended for use in the antenna shelters or in areas with strong radio-frequency fields, irrespective of their origin.

29) An autonomous electronic system as claimed in any of the above claims characterized by the fact that it is intended for use in the mobile telephony antenna shelters.

30) An autonomous electronic system as claimed in any of the above claims characterized by the fact that it operates under a unified software system which can be configured according to the customer needs (custom made).

31) An autonomous electronic system as claimed in any of the above claims characterized by the fact that when an authorized person is present in the monitored/controlled area, no action can take place either remotely from the operator of the central remote control system, or locally, to protect the individuals present.

32) An autonomous electronic system as claimed in any of the above claims characterized by the fact that even when there is no communication with the central remote control center the system operates normally, as programmed and configured to operate, storing at least 5.000 data in the microprocessor memory <<buffer>> so that when communication is restored it will transmit normally all the data memorized.

33) An autonomous electronic system as claimed in any of the above claims characterized by the fact that the electronic boards are placed in two boxes consisting of a base, four sidewalls and a removable door/cover and are constructed of material (e.g. metal), providing safety to the personnel, protection from environmental agents and electromagnetic shield from and to the environment.
